(19) United States
(12) Patent Application Publication
(10) Pub. No.: US 2014/0089379 A1
(43) Pub. Date: Mar. 27, 2014

(54) SYSTEMS AND METHODS FOR COLLABORATIVE MOBILE DEVICE APPLICATIONS

(71) Applicant: APPSENSE LIMITED, Warrington (GB)

(72) Inventor: Anthony Thomas DAVIS, Lancashire (GB)

(73) Assignee: APPSENSE LIMITED, Warrington (GB)

(21) Appl. No.: 13/625,061

(22) Filed: Sep. 24, 2012

(51) Int. Cl. G06F 15/16

(52) U.S. Cl. 709/203

(57) ABSTRACT

Systems and methods are provided for collaborative mobile device applications. Mobile device applications for a mobile device are stored in a database. The mobile device applications include an interface defining how each mobile device application interacts with the other mobile device applications. Each mobile device application provides a set of services and/or features for a virtual application, wherein the virtual application is defined by the mobile device applications and their associated interfaces. The mobile device applications are configured such that a mobile device can download at least two different subsets of the mobile device applications, wherein each subset provides different functionality for the virtual application.

### BACKGROUND

Computing devices often download software applications from application stores (or virtual marketplaces), where computer applications can be previewed and downloaded to the computing device (e.g., after payment, or after a request from the computing device). For example, the applications can include mobile phone applications that a user can download to their smartphone, such as games, word processing applications, and applications developed by companies for their customers (e.g., banking applications, stock trading applications, restaurant applications, etc.). A computing device can access the application store (e.g., via a webpage or via a separate application) to browse the list of available applications, and then request that one or more applications be downloaded to the computing device. Such applications are available for download to various types of computing devices, including smartphones, desktops, laptops, tablets, and/or the like.

The applications often implement the sandbox application paradigm such that each application can be installed on, or uninstalled from, a mobile device without affecting surrounding applications or the mobile device's operating system. Such “sandboxed” applications typically can only operate on data generated and/or stored by the application itself, and not data generated/stored by other applications (e.g., collected data, computational results, database entries, personal profile information, statistics, and/or the like). Further, while sandboxed applications can use services provided by the host operating system (e.g., user interface functions, memory management, etc.), such applications often cannot use services provided by other applications on the computing device. The result is a set of easily downloadable applications, however they are often just small, isolated programs that cannot take advantage of the services or features available from other applications (e.g., a clock, a game, a notepad, etc.).

### SUMMARY

In accordance with the disclosed subject matter, systems, methods, and non-transitory computer-readable media are provided for collaborative mobile device applications. Custom interfaces define how a set of applications (e.g., mobile device applications) interact amongst each other to create a larger virtual application (e.g., an application whose underlying functionality is defined by the interactions among the set of applications). Since services and/or features for the virtual application are defined by the set of applications, the interfaces can be designed such that different subsets of the applications can be downloaded by a requesting device. For example, various levels of functionality can be downloaded for a particular virtual application (e.g., by including or not including underlying applications for particular downloads from the application store).

The disclosed subject matter includes a computerized method for providing a virtual mobile device application to a mobile device. The method includes storing, by a computing device, at least three mobile device applications for a mobile device in a database. Each of the at least three mobile device applications includes an interface defining how each mobile device application interacts with the remaining of the at least three mobile device applications. Each of the at least three mobile device applications provides at least one of a set of services and a set of features for a virtual application, wherein the virtual application is defined by the at least three mobile device applications and their associated interfaces. The method includes storing, by the computing device, configuration information for the virtual application in the database such that the mobile device can selectively download at least two different subsets of the at least three mobile device applications, wherein each of the two different subsets provides different functionality for the virtual application.

The disclosed subject matter further includes an application server for providing a virtual mobile device application to a mobile device. The application server includes one or more interfaces configured to provide communication with a mobile device via a communication network. The application server includes a database. The application server includes a processor, in communication with the one or more interfaces and the database, and configured to run a module stored in memory that is configured to cause the processor to store at least three mobile device applications for a mobile device in the database. Each of the at least three mobile device applications comprises an interface defining how each mobile device application interacts with the remaining of the at least three mobile device applications. Each of the at least three mobile device applications provides at least one of a set of services and a set of features for a virtual application, wherein the virtual application is defined by the at least three mobile device applications and their associated interfaces. The module is configured to cause the processor to store configuration information for the virtual application in the database such that the mobile device can selectively download at least two different subsets of the at least three mobile device applications, wherein each of the at least two different subsets provides different functionality for the virtual application.

The disclosed subject matter further includes a non-transitory computer readable medium having executable instructions operable to cause an apparatus to store at least three mobile device applications for a mobile device in a database. Each of the at least three mobile device applications comprises an interface defining how each mobile device application interacts with the remaining of the at least three mobile device applications. Each of the at least three mobile device applications provides at least one of a set of services and a set of features for a virtual application, wherein the virtual application is defined by the at least three mobile device applications and their associated interfaces. The executable instructions are further operable to cause an apparatus to store configuration information for the virtual application in the database such that the mobile device can selectively download at least two different subsets of the at least three mobile device applications, wherein each of the at least two different subsets provides different functionality for the virtual application.

Such virtual applications, built from a set of underlying applications that interact via custom defined interfaces, allow a user to tailor his purchase based on desired functionality for the virtual application (e.g., a full set of applications can be downloaded for full price, or a subset of applications that offers limited functionality can be downloaded for less). Additionally, users can define their own application interfaces to extend a virtual application (or application swarm) to include desired functionality (e.g., not offered from the application store). For example, a company can provide an enterprise application store, and customize applications for the company (e.g., such that existing applications are tailored to include functionality specific to the company). Additionally, since the interaction among applications is defined by the interfaces, developers can build applications independent of other applications.

These and other capabilities of the disclosed subject matter will be more fully understood after a review of the following figures, detailed description, and claims. It is to be understood that the phraseology and terminology employed herein are for the purpose of description and should not be regarded as limiting.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is an exemplary diagram of a networked system for collaborative mobile device applications in accordance with some embodiments of the invention.

FIG. 2A is an exemplary diagram of a set of mobile device applications for a virtual mobile device application in accordance with some embodiments of the invention.

FIG. 2B is an exemplary diagram of a set of mobile device applications for a virtual mobile device application in accordance with some embodiments of the invention.

FIG. 2C is an exemplary diagram of a set of mobile device applications for a virtual mobile device application in accordance with some embodiments of the invention.

FIG. 3 is an exemplary computerized method for providing collaborative mobile device applications in accordance with some embodiments of the invention.

FIG. 4 is an exemplary computerized method for updating collaborative mobile device applications in accordance with some embodiments of the invention.

FIG. 5 is an exemplary computerized method for adding to collaborative mobile device applications in accordance with some embodiments of the invention.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid unnecessary complication of the disclosed subject matter. In addition, it will be understood that the embodiments provided below are exemplary, and that it is contemplated that there are other systems and methods that are within the scope of the disclosed subject matter.

The disclosed techniques enable an administrative user at an administrative console or device to create collaborative virtual mobile device applications (also referred to herein as “virtual applications”) that can be downloaded from a centralized application server to individual mobile devices. A virtual application is defined by a set of separate mobile device applications, each of which includes interface(s) that define how the mobile device applications interact to create the virtual application. Each mobile device application in the set defines different services and/or features of the virtual application. The administrative console stores configuration information for the virtual mobile device applications, such that a mobile device can download different subsets of the mobile device applications (e.g., depending on a desired functionality for the virtual application, a price associated with the subsets, etc.).

Corporations and organizations can define the virtual applications, and add to and/or remove features from the virtual applications by adding/removing mobile device applications. Further, since the mobile device applications are autonomous, each mobile device application can be developed and tested independently from the remaining mobile device applications that define a particular virtual application. Updates to individual mobile device applications can be distributed to mobile devices without affecting the remaining mobile device applications on each mobile device.

A virtual application is structured from the underlying set of applications, which are building blocks for the virtual application. Therefore, larger virtual applications can be built by combining many smaller applications. Each application can be developed independently (e.g., as long as the application adheres to its interfaces defined for interaction with other applications). While some operating systems support application interfaces (e.g., iOS 6, Windows® 8 Style), such interfaces are not used to build virtual applications, but rather to simply integrate one application into another to create a “built-in” application (e.g., so a word processing application can print a document type supported by a second application, such as Adobe PDF). Other examples of such built-in applications are viewing a document type supported by a second application, or storing a document on a remote storage device (e.g., Dropbox).

Built-in applications are very distinct, single applications (e.g., single producer to single consumer), whereas virtual applications are much more granular and cohesive. The interactions of the virtual application are under the control of the virtual application rather than needing to be guided by the user. In this way, a collection of applications “swarm” together to appear as a single larger, virtual application to the user. For example, a collaborative virtual application could have 3 applications 1, 2 and 3; application 1 could request application 2 to provide a service which application 2 itself passes on to application 3 to provide without application 1 being aware.

In contrast, the techniques described herein utilize a set of applications, in combination with interfaces for the applications, to build a set of collaborating applications to define a virtual application. The interface(s) between two applications define a contract between the two applications. Therefore interfaces between two applications creates an agreement between the two applications, defining how the applications will exchange information. The information can be exchanged using, e.g., function calls/messages. The data exchanged can be of particular types defined by the contract. For example, a developer can define a set of interfaces for a particular virtual application, and add applications to the virtual application to implement desired services, features, etc. for the virtual application. For example, a virtual application can define a set of interfaces and protocols for the virtual application, which allows third parties to contribute to the virtual application by developing applications for the virtual application that abide by the defined interfaces.

As an illustrative example, a virtual photo album application can include a subset of applications that interact with each other to provide the virtual photo album's functionality, which can include a photograph application (e.g., which stores photographs, and allows a user to add/remove photographs), an album application (e.g., which allows a user to organize photographs from the photograph application), and a metadata application (e.g., which adds context data to the photographs, which can be used to generate captions for the photographs in the album application). Further, for example, a user can download all three applications for the virtual photo album application. Or, the user can download a subset of the applications, such as just the photograph application and the album application, and not the metadata application (e.g., so the user can create photo albums, but will not be able to add metadata with the metadata application). In contrast, in the past, applications are often downloaded as single applications rather than sets of applications. With single applications, a software developer must make separate versions of each application to offer different versions to a user, rather than allowing a user to pick-and-choose the functionality the user desires. Further, the entire application must be edited to change its functionality (e.g., which makes modifying an application and/or updating an application on a user's phone more difficult than with sets of applications, as explained further herein).

As another example, one application can request another application to perform a search on its data. For example, an application can request a user's personal contact application (e.g., address book) to search the user's contacts (e.g., based on the contact name, address, phone number, etc.). As a further example, an application can request a user's credentials from a credentials application (e.g., to verify the identity of the user, to automatically log the user into a secure website, etc.).

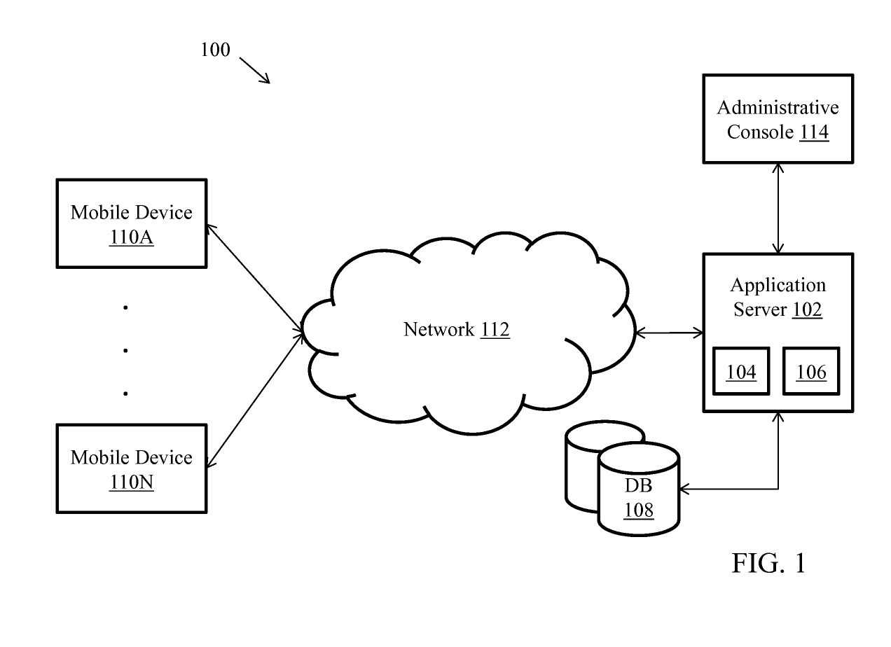

FIG. 1 is an exemplary diagram of a system 100 for collaborative mobile device applications in accordance with some embodiments of the invention. System 100 includes application server 102, which has memory 104 and processor 106. Application server 102 is in communication with database 108. The application server 102 is in communication with mobile devices 110A through 110N (collectively, mobile devices 110) through network 112. Application server 102 is also in communication with administrative console 114. While the system 100 shows the application server 102 connected to the database 108 and the administrative console 114 separately from network 112, in some embodiments the application server 102 is in communication with the database 108 and/or the administrative console 114 via network 112. Further, while FIG. 1 shows mobile devices 110, any device can use the services of the application server 102, such as smartphones, desktops, laptops, tablets, and/or the like.

The application server 102 provides virtual applications to mobile devices 110. Virtual applications are built up from various separate applications that include interfaces such that the mobile device applications interact with one another to define the functionality and/or features of the virtual application. Therefore, the virtual application is not a single application, but instead is built up from the various interactions among a set of applications (e.g., from a set of separately executing mobile device applications). While many examples herein address building virtual applications using a set of mobile device applications, any type of application can be used without departing from the techniques described herein.

The communication network 112 can include a network or combination of networks that can accommodate private data communication. For example, the communication network 112 can include a local area network (LAN), a private cellular network, a private telephone network, a private computer network, a private packet switching network, a private line switching network, a private wide area network (WAN), or any number of private networks that can be referred to as an Intranet. Such networks may be implemented with any number of hardware and software components, transmission media and network protocols. FIG. 1 shows the network 112 as a single network; however, the network 112 can include multiple interconnected networks listed above.

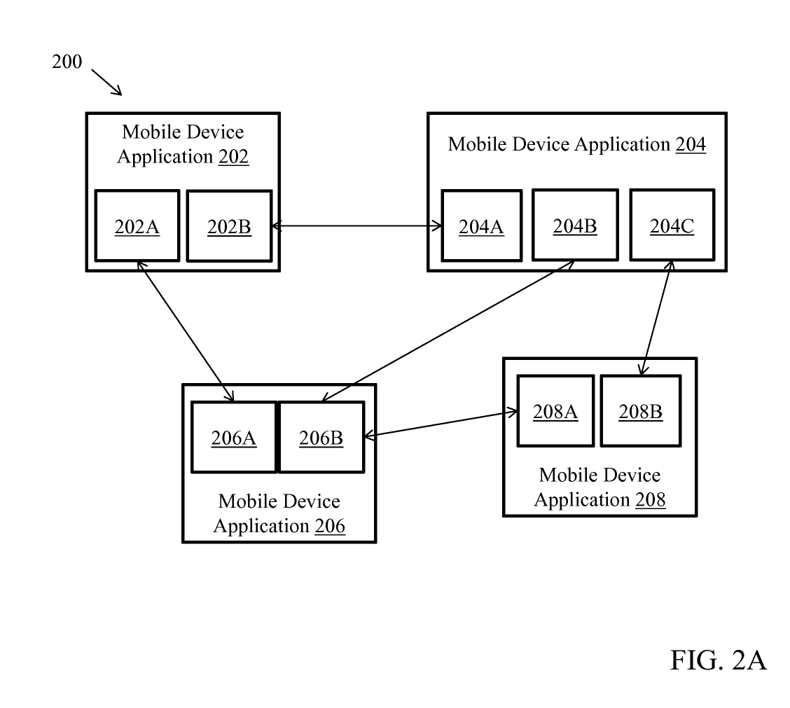

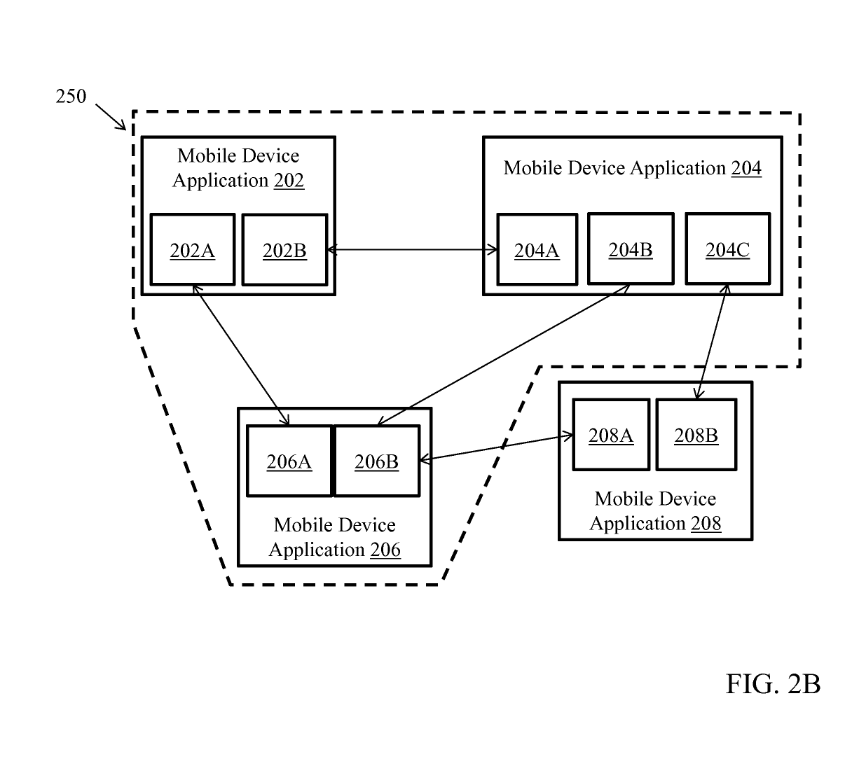

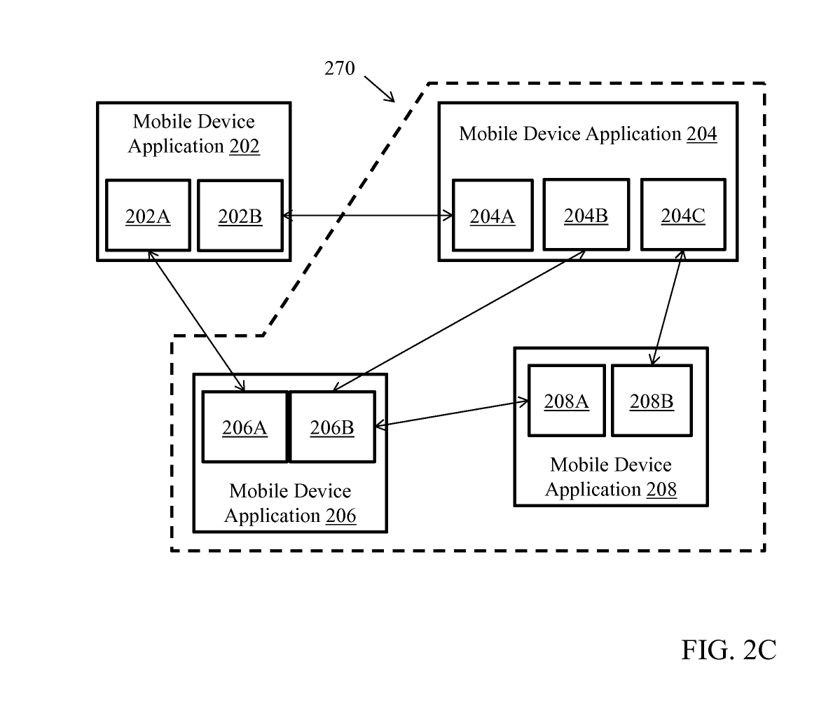

FIG. 2A is an exemplary diagram of a set of mobile device applications 200 for a virtual application in accordance with some embodiments of the invention. The set of mobile device applications 200 includes mobile device application 202, mobile device application 204, mobile device application 206, and mobile device application 208. Mobile device application 202 includes interfaces 202A and 202B. Mobile device application 204 includes interfaces 204A, 204B and 204C. Mobile device application 206 includes interfaces 206A and 206B. Mobile device application 208 includes interfaces 208A and 208B.

While FIG. 2A shows a particular number of interfaces for each mobile device application (e.g., mobile device application 202 includes two interfaces 202A, 202B), each mobile device application can have any number of interfaces. For example, each mobile device may have an individual interface for each mobile device application it communicates with, it may include a single interface that it uses to communicate with all other mobile device applications, and/or the like. Further, while FIG. 2A shows four mobile device applications 202, 204, 206 and 208 for a virtual application, any number of mobile device applications can be used to define a virtual application. For example, a virtual application can include two, three, four, and/or any number of virtual applications (e.g., which can be added to add new services and/or features to the virtual application). For example, the database 108 stores a set of mobile device applications that are associated with a particular virtual application. In some examples, the mobile device applications of a particular set can be associated with a plurality of virtual applications (e.g., if two virtual applications use a same mobile device application, two separate copies of the same mobile device application need not be stored in database 108).

Each mobile device application provides a set of services, features, or both, for a virtual application. At a basic level, existing mobile device applications can be extended with newly-defined interfaces to combine the applications with other mobile device applications to effectively create a larger application (which consists of the separately executing mobile device applications). The mobile device application services can include, for example, any type of software functionality, such as functions, methods, macros, and/or other types of software functions (e.g., a GPS location method, a database storage method, mathematical calculations, statistical computations, document editing functions, display functions, data entry functions, memory management functions, data access functions, etc.). The mobile device application features can include, for example, any type of data that can be shared among applications (e.g., the results of functions/methods performed by an application, such as computed data, data tags, calculation results, stored data, historical data, user profile data, encryption keys, etc.).

Each of the mobile device applications in the set include one or more interfaces that define how the mobile device application interacts with the remaining set of mobile device applications to create the virtual application. Interfaces can be created that are specific to a virtual application (e.g., to implement custom features or interactions for the specific virtual application, which may be useful only for the virtual application and not for other applications). The interfaces define how the mobile device applications interact to create the larger virtual application (e.g., collaborative application collections, that work together to provide the complete virtual application). For example, an existing mobile device application can be modified to include a new interface so the application can be incorporated into a virtual application. The interfaces can, for example, define how data is shared or how services for an application can be invoked by another application. As an example, the interface can be a collection of function calls and values that a software application (or module therein) implements and guarantees to provide to other applications. A second application (or module) that wishes to use the application can make assumptions about how the module will behave based on its defined interface.

Mobile device application 202 uses interface 202A to communicate with mobile device application 206 via interface 206A, and uses interface 202B to communicate with mobile device application 204 via interface 204A. Mobile device application 204 uses interface 204A to communicate with mobile device application 202 via interface 202B, uses interface 204B to communicate with mobile device application 206 via interface 206B, and uses interface 204C to communicate with mobile device application 208 via interface 208B. Mobile device application 206 uses interface 206A to communicate with mobile device application 202 via interface 202A, and uses interface 206B to communicate with mobile device application 204 via interface 204B and mobile device application 208 via interface 208A. Mobile device application 208 uses interface 208A to communicate with mobile device application 206 via interface 206B, and uses interface 208B to communicate with mobile device application 204 via interface 204C.

The set of mobile device applications 200 can be downloaded in their entirety to provide the full set of functionality available for the virtual application (e.g., when the set of mobile device applications 200 are executed on a requesting mobile device). In some examples, subsets of the set of mobile device applications 202 can be downloaded such that, once executed, the virtual application only provides limited functionality based on the downloaded mobile device applications (e.g., since each of the mobile device applications in the set 200 can execute autonomously from the remaining applications). For example, FIG. 2B shows a subset 250 of mobile device applications 202, 204 and 206 that can be downloaded to a requesting mobile device. The resulting virtual application, when the subset 250 is executed on a mobile device, includes the services and/or features of mobile device applications 202, 204 and 206, but does not include the services and/or features of mobile device application 208. As another example, FIG. 2C shows a subset 270 of mobile device applications 204, 206 and 208 that can be downloaded to a requesting mobile device. The resulting virtual application, when the subset 270 is executed on a mobile device, includes the services and/or features of mobile device applications 204, 206 and 208, but does not include the services and/or features of mobile device application 202. While FIGS. 2B-2C show various subsets of mobile device applications, any number and/or combination of mobile device applications can be used without departing from the techniques described herein.

Processor 106 can be configured to implement the functionality described herein using computer executable instructions stored in a temporary and/or permanent non-transitory memory such as memory 104. Memory 104 can be flash memory, a magnetic disk drive, an optical drive, a programmable read-only memory (PROM), a read-only memory (ROM), or any other memory or combination of memories. The processor 106 can be a general purpose processor and/or can also be implemented using an application specific integrated circuit (ASIC), programmable logic array (PLA), field programmable gate array (FPGA), and/or any other integrated circuit. Similarly, database 108 may also be flash memory, a magnetic disk drive, an optical drive, a programmable read-only memory (PROM), a read-only memory (ROM), or any other memory or combination of memories. The application server 102 can execute an operating system that can be any operating system, including a typical operating system such as Windows, Windows XP, Windows 7, Windows 8, Windows Mobile, Windows Phone, Windows RT, Mac OS X, Linux, VXWorks, Android, Blackberry OS, iOS, Symbian, or other OS.

The components of system 100 can include interfaces (not shown) that can allow the components to communicate with each other and/or other components, such as other devices on one or more networks, server devices on the same or different networks, or user devices either directly or via intermediate networks. The interfaces can be implemented in hardware to send and receive signals from a variety of mediums, such as optical, copper, and wireless, and in a number of different protocols some of which may be non-transient.

The software in application server 102 can be divided into a series of tasks that perform specific functions. These tasks can communicate with each other as desired to share control and data information throughout application server 102. A task can be a software process that performs a specific function related to system control or session processing. Three types of tasks can operate within application server 102 in some embodiments: critical tasks, controller tasks, and manager tasks. The critical tasks can control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem (as described below), and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem can be a software element that either performs a specific task or is a culmination of multiple other tasks. A single subsystem includes critical tasks, controller tasks, and manager tasks. Some of the subsystems that run on application server 102 include a system initiation task subsystem, a high availability task subsystem, a shared configuration task subsystem, and a resource management subsystem.

The system initiation task subsystem can be responsible for starting a set of initial tasks at system startup and providing individual tasks as needed. The high availability task subsystem can work in conjunction with the recovery control task subsystem to maintain the operational state of application server 102 by monitoring the various software and hardware components of application server 102. Recovery control task subsystem can be responsible for executing a recovery action for failures that occur in application server 102 and receives recovery actions from the high availability task subsystem. Processing tasks can be distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will preferably not be affected by that problem.

A shared configuration task subsystem can provide the application server 102 with an ability to set, retrieve, and receive notification of server configuration parameter changes and is responsible for storing configuration data for the applications running within the application server 102. A resource management subsystem can be responsible for assigning resources (e.g., processor and memory capabilities) to tasks and for monitoring the task's use of the resources.

In some embodiments, application server 102 can reside in a data center and form a node in a cloud computing infrastructure. Application server 102 can also provide services on demand such as Kerberos authentication, HTTP session establishment and other web services, and other services. A module hosting a client can be capable of migrating from one server to another server seamlessly, without causing program faults or system breakdown. An application server 102 in the cloud can be managed using a management system.

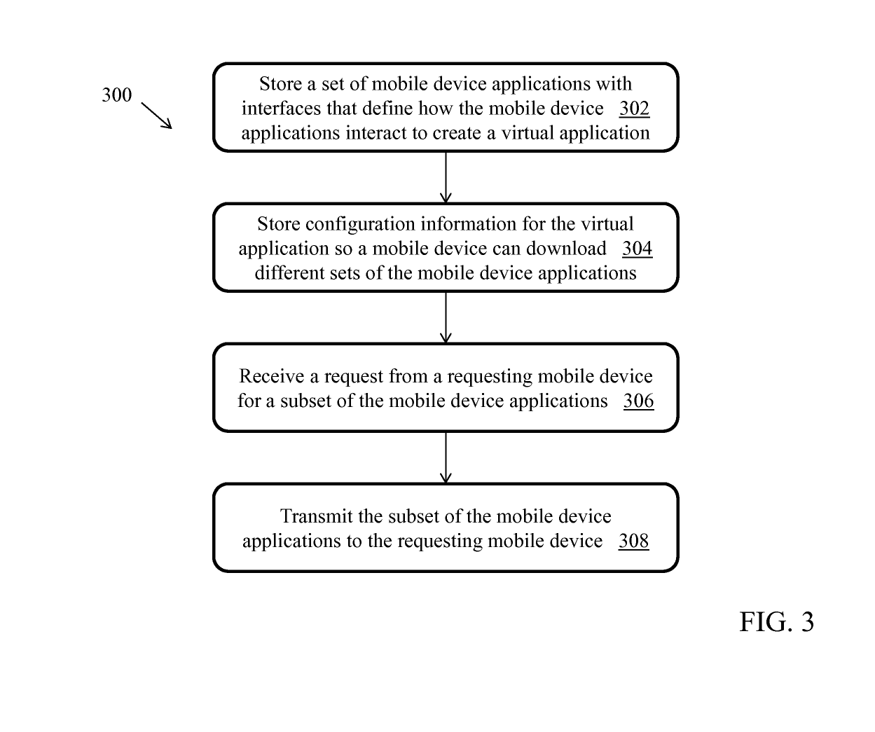

Application server 102 stores the set of applications for a particular virtual application, and includes configuration information that defines the various subsets of applications that can be downloaded for a particular virtual application (e.g., subsets 250 and 270). FIG. 3 is an exemplary computerized method 300 for providing collaborative mobile device applications in accordance with some embodiments of the invention. The method 300 is exemplary only, and can be modified by, for example, rearranging, altering, and/or omitting certain steps. Referring to FIGS. 1 and 3, at step 302 the application server 102 stores a set of mobile device applications (e.g., three or more mobile device applications) in database 108. At step 304, the application server 102 stores configuration information for the virtual application in database 108 such that a mobile device 110 can selectively download different subsets (e.g., two or more different subsets) of the set of mobile device applications. As described above with reference to FIGS. 2B-2C, each subset provides different functionality for the virtual application (e.g., when executed on the mobile device).

At step 306, the application server 102 receives a request from a requesting mobile device (e.g., mobile device 110A) for a subset of the set of mobile device applications (e.g., the full set of mobile device applications 200 of FIG. 2A, or a portion thereof, such as subset 250 or 270 of FIGS. 2B-C, respectively). At step 308, the application server 102 transmits the subset of the mobile device applications to the requesting mobile device (e.g., to mobile device 110A).

Referring to step 302, as described above with reference to FIG. 2A, each of the mobile device applications in the set has one or more interfaces that define how each mobile device application interacts with one or more remaining mobile device applications in the set. Each of the mobile device applications provides a set of services and/or features for the associated virtual application, which is created upon execution of the mobile device applications (or a subset thereof) on a mobile device.

Referring to step 304, the configuration information defines the various versions of a virtual application available for download to a mobile device. For example, a particular version may support an associated subset of mobile device applications available for a virtual application. For example, a mobile device may access an application store hosted by the application server 102 that allows the mobile device to browse the different versions available for a virtual application (e.g., where each version is associated with a different subset of mobile device applications for the virtual application). In some examples, each version may be associated with a different price. For example, a version that includes the full set of mobile device applications (e.g., and therefore the fully available set of services and/or features for the associated virtual application) may cost the most to download. As various services and/or features are removed (e.g., by excluding mobile device applications for download), the cost to download the associated virtual application version may decrease.

Referring to step 306, for example, the mobile device can request one or more different versions of a mobile device application for download. For example, a mobile device may request the full version of a particular virtual application, and the application server 102 will transmit all of the associated mobile device applications for the virtual application to the requesting mobile device. In some embodiments, the mobile device requests a version from an application store (e.g., such as that provided by a company to consumers, a university to students, an employer to employees, etc.).

Referring to step 308, the application server 102 can perform any necessary validation before transmitting the subset (or version) to the requesting mobile device. For example, the application server 102 may verify payment, the identity of the requesting device, permissions, security parameters, etc. before transmitting the set of mobile device applications to the requesting device. Once the applications are downloaded and executed on the requesting mobile device, the virtual application is executed as the sum of the services and features for each particular application, and the interactions among the mobile device applications as defined through their associated interfaces. For example, if all associated mobile device applications are downloaded and executed, the resulting virtual application includes the full range of services and features available for the virtual application (e.g., since all possible mobile device applications associated with the virtual application were downloaded to the mobile device), as well as those that result from combining the applications (e.g., which could not be offered by the individual applications). In other examples, the mobile device can request a subset of the full set of mobile device applications, and the resulting virtual application will only have limited functionality and/or features based on the downloaded virtual applications (e.g., the functionality and/or features of the mobile device applications that were not included in the subset will, in turn, not be present in the virtual application).

As an illustrative example, see U.S. patent application Ser. No. 13/568,528, filed on Aug. 7, 2012, entitled “Adaptive Document Redaction,” which is incorporated by reference herein in its entirety, and describes a document redaction and management system configured to allow a user to access to various levels of redacted documents based on the user's geographical location. For example, if a requesting device is in a private location (e.g., in a user's home), then the data repository may grant a requesting device full access to a particular document, whereas if the requesting device is in a public area, the requesting device is only granted partial access to the document such that a redacted document is presented instead of the original underlying document (e.g., so confidential information is not included in the document). An exemplary virtual application can be a data repository virtual application that is built from a set of applications that collectively work among each other to implement the functionality described in the above-referenced application.

For example, the set of applications that make up the data repository application, which interact through defined interfaces, can include: (1) a data repository application that stores the source documents (e.g., which includes an interface for accessing the documents, or versions thereof), (2) a location application that determines a computing device's geographical location (e.g., using GPS and/or the like, which includes an interface that defines how to request the location of the computing device), (3) a redaction application that creates the various levels of redacted documents for a document (e.g., which creates a first redacted document for a public location, a second redacted document for a private location, and so on), (4) an authentication application that determines whether a user can access a particular document based on the computing device's location (e.g., which includes an interface to the location application so that it can request the computing device's location, and an interface so that other programs can request authentication of a computing device), (5) a security application that stores encryption information and encrypts the underlying source documents stored in the data repository so they cannot be improperly accessed by a computing device in an improper geographical location (e.g., which provides an interface to the data repository application and controls access to the documents using security data, such as a private key for a requesting computing device), and (6) a viewing application for displaying the requested document (whether it be a redacted document or a complete copy of the original document). While this example is used for illustrative purposes, it should be clear that the data repository virtual application can include more than six applications, less than six applications, any other suitable application, and/or any suitable combination of applications.

Executing the six applications listed above creates a virtual data repository application on the executing device. An illustrative example of how the applications interact via the defined interfaces to create the virtual application is described next. A document is loaded into the data repository by the data repository application (1). Upon ingest, the data repository application (1) uses the redaction application (3) to generate a set of redacted documents for the ingested document, where each redacted document is associated with a particular viewing location. A computing device makes a request to the viewing application (6) to view a particular document from the set of redacted documents. The viewing application (6) sends a request to the authentication application (4) (via an interface defined by the authentication application (4)) to authenticate the requesting device to determine whether the device is allowed access to the particular document. The authentication application (4) queries the location application (2), via the location application's (2) interface, to determine the location of the requesting device. The location application (2) determines the geographical location of the computing device, and returns the result to the authentication application (4). If the authentication application (4) determines the requesting device can access the requested document at the device's location, the authentication application (4) transmits an authentication confirmation to the viewing application (6), otherwise the authentication application (4) transmits an authentication denial to the viewing application (6).

If the viewing application (6) receives an authentication confirmation from the authentication application (4), the viewing application (6) requests the particular document from the data repository application (1). Once received, the viewing application (6) decrypts the document using the security application (5) (e.g., based on the requesting device's signature, private key, etc.). Once decrypted, the viewing application (6) displays the decrypted document to the requesting device. Beneficially, the requesting device need not be involved with the encryption or the creation of the redacted documents, as all such processing occurs transparently to the user of the computing device.

In some examples, the virtual application is a graphical user interface that displays data from a set of mobile device applications. For example, the graphical user interface can have multiple display areas (e.g., portions of the computing device's display) that render content from one or more applications from the set of virtual application. The graphical user interface can include two or more display areas, where each display area renders content from a particular mobile device application. For example, a first display area displays pictures from a user's photo album (e.g., using the computing device's photo album application), and the second display area displays a photo editing application. In some examples, one or more of the display areas renders content from multiple applications (e.g., a display area can display photos using the computing device's photo album application, as well as a second application that loads photos from the internet or cloud storage).

As another example, a first display area displays pictures from a user's photo album (e.g., using the computing device's photo album application), and the second display area displays a tagging application so data tags can be associated with the photo (e.g., so a user can easily search their photos using text-based queries). An additional application can be running without a display component that also generates tags or metadata for the photos (e.g., a location application, which tags the location where ach photo is captured by the computing device).

As another example, a virtual application can consist of four applications that allow a user to search for data using meta data: application 1—a user credentials/tagging manager, application 2—associative meta data store, application 3—a data viewing application, and application 4—a data store. Application 1 can be configured to tag data. For example, a tag can be added to a data item to provide more information about the data item. For example, a tag can have the syntax: {<tagname>//<tag value type>//<tag value>}). As an example, a location tag can be completed as: {Location//location_t//London}, and a dateTaken tag can be completed as {DateTaken//Date//01/01/2012}. Application 2, can store the typed (meta) tags are //separately from the tagged item. This can be done, for example, for performance reasons, as this can allow the tags to be searched without having to retrieve the actual data items in storage (e.g., the data items may be stored in separate locations on storage that may be slow to access). The tag store can be optimized for search operations.

Application 3 can be used to perform searches of the data stored in the data store using the meta data. A value add for tags is that they can be used to allow data items to be grouped according to the tags associated with them. For example, a user can search for all pictures that have the following tags conditions (continuing with the location and dateTaken tags above): a/ Location=London, and b/ DateTaken>02/03/2012. Application 4 is the data store, and stores the data associated with the tags in application 2.

When a user invokes the virtual application, the data viewer application 3 retrieves the users credentials from application 1 (e.g., to verify the user), it the performs a search in application 2 to retrieve a collection of references to data items. For example, application 2 can return a set or collection of references to data item(s) that are tagged with the requested meta data (e.g., both Location and a DataTaken tags whose values match the search criterion above). The search results from application 2 are only references, because the tag database is separate from the data items stored in application 4. Further, in some examples one or more data items returned are physically stored on a separate data store (e.g. dropbox and skydrive). The references obtained are then used to obtain the corresponding data from data store application 4 (e.g., the data associated with the retrieved meta data)which is then displayed to the user by application 3.

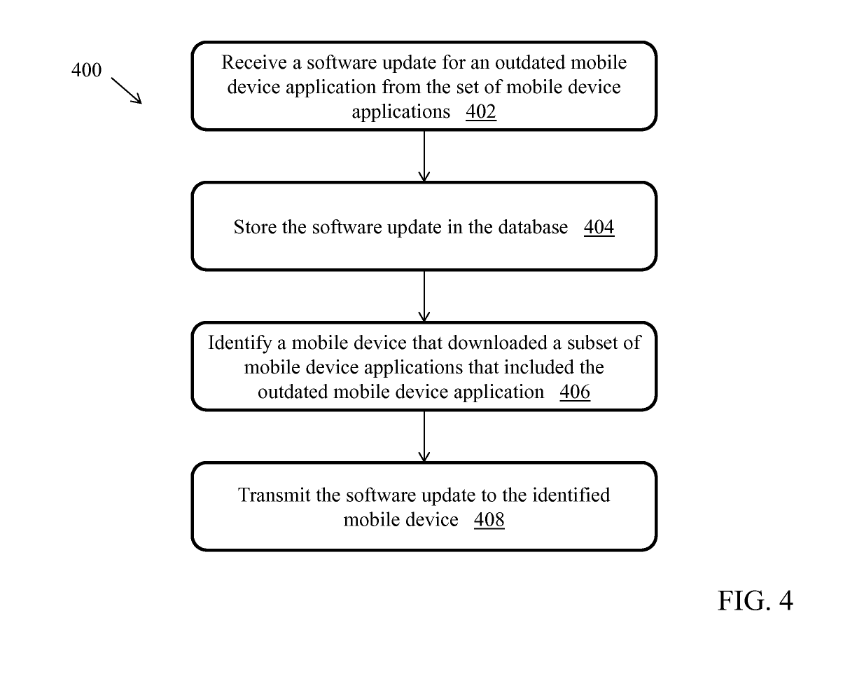

FIG. 4 is an exemplary computerized method 400 for updating collaborative mobile device applications in accordance with some embodiments of the invention. The method 400 is exemplary only, and can be modified by, for example, rearranging, altering, and/or omitting certain steps. Referring to FIGS. 1 and 4, at step 402 the application server 102 receives a software update for an outdated mobile device application from the set of mobile device applications (e.g., for mobile device application 202 of FIG. 2). At step 404, the application server 102 stores the software update in the database 108. At step 406, the application server 102 identifies a mobile device (e.g., mobile device 210A) that downloaded a set of mobile device applications (or a subset thereof) that included the outdated mobile device application. At step 408, the application server 102 transmits the software update to the identified mobile device (e.g., to mobile device 210A).

Referring to step 402, the application server 102 can receive periodic updates for mobile device applications (e.g., which are stored on the database 108). For example, as mobile device application providers continue to develop applications, new releases and/or versions of the mobile device applications can be uploaded to the application server 102 so the available sets of mobile device applications are up to date.

Referring to step 404, the application server 102 can store the software update in the database 108 by replacing the outdated mobile device application with the updated mobile device application. In some examples, multiple copies of the outdated application may reside in the database 108 (e.g., if each virtual application that uses the mobile device application stores a unique set of applications rather than sharing the applications). The application server 102 can replace each copy of the outdated mobile device application.

Referring to step 406, the application server 102 can identify the set of mobile devices that downloaded the outdated mobile device application by consulting database records that keep track of content downloaded from the application server 102. For example, the application server 102 can store records (e.g., in database 108) to keep track of all virtual applications (and their associated mobile device applications) that were downloaded, and to which devices (e.g., by storing a MAC address, phone number, or other type of identifier for each mobile device).

Referring to step 408, the application server 102 can transmit a notification to the identified mobile device, informing the mobile device that a software update is available. For example, rather than automatically transmitting the updated software to the mobile device, it can leave it up to the mobile device (or the operator of the mobile device) to determine whether to download the updated mobile device application. If the application server 102 receives a confirmation from the mobile device to download the software update to the mobile device, the application server 102 can then transmit the updated mobile device application (or updates thereof) to the mobile device.

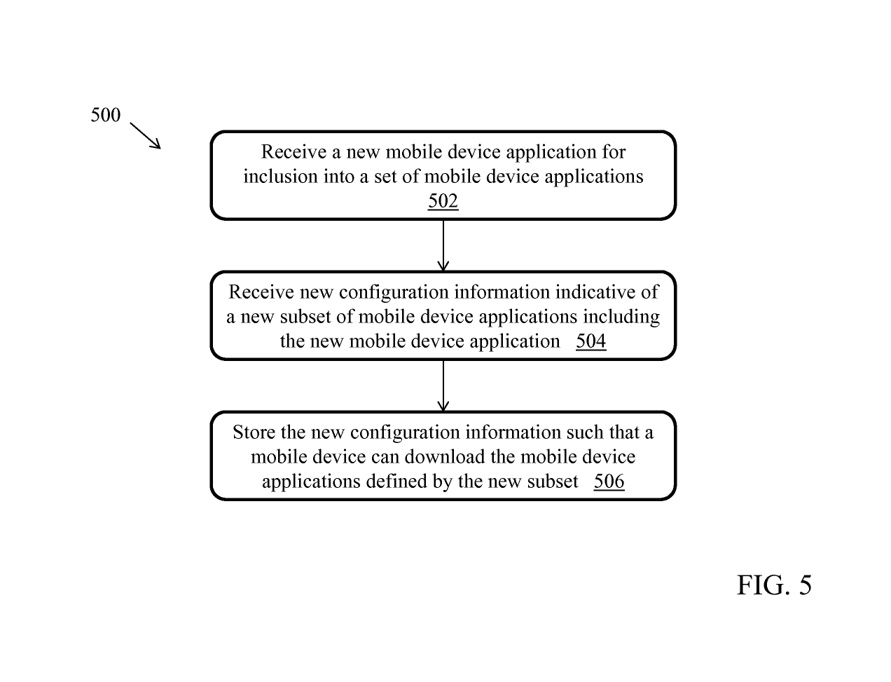

FIG. 5 is an exemplary computerized method 500 for adding to collaborative mobile device applications in accordance with some embodiments of the invention. The method 500 is exemplary only, and can be modified by, for example, rearranging, altering, and/or omitting certain steps. Referring to FIGS. 1 and 5, at step 502, the application server 102 receives a new mobile device application for inclusion into a set of mobile device applications. At step 504, the application server 102 receives new configuration information indicative of a new subset of mobile device applications that include the new mobile device application. At step 506, the application server 102 stores the new configuration information in the database 108. As defined by the new configuration information, a mobile device (e.g., mobile device 110A) can download the mobile device applications defined by the new subset of mobile device applications.

Referring to step 502, mobile device application developers may wish to add one or more new mobile device applications to a particular virtual application. For example, the mobile device applications can be added to enhance the services and/or features of a particular virtual application. The new mobile device application can include an interface that defines how the new mobile device application interacts with the existing set of mobile device applications for the virtual application. The new mobile device application can provide a new set of services, a new set of features, or both, to the virtual application. Once added, the virtual application is defined by the previously existing set of mobile device applications, as well as the new mobile device application.

Referring to step 504, the application server 102 receives new configuration information indicative of a new subset of mobile device applications that include the new mobile device application. For example, the new configuration information can provide one or more versions of the virtual application (e.g., for download to a mobile device) that include the newly added mobile device application. For example, the configuration information can create a new version that includes the new mobile device application and two or more mobile device applications from the set of mobile device applications for the virtual application. In some examples, new configuration information can add and/or change existing versions of the virtual application (e.g., without adding a new mobile device application to the set of applications for a virtual application). For example, referring to FIG. 2B, the subset 250 can be modified to include mobile device application 208, to no longer include mobile device application 206, and/or the like.

Referring to step 506, the configuration information can support incremental downloads to an already-existing virtual application on a mobile device. For example, a mobile device may already have a version of the virtual application installed on the device (and therefore a particular subset of mobile device applications associated with the virtual application). If the mobile device requests a version with additional functionality, only the necessary mobile device applications required to support the new functionality can be downloaded to the mobile device (rather than downloading the previously-installed applications).

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A computerized method for providing a virtual mobile device application to a mobile device, the method comprising:
storing, by a computing device, at least three mobile device applications for a mobile device in a database, wherein:
each of the at least three mobile device applications comprises an interface defining how each mobile device application interacts with the remaining of the at least three mobile device applications; and
each of the at least three mobile device applications provides at least one of a set of services and a set of features for a virtual application, wherein the virtual application is defined by the at least three mobile device applications and their associated interfaces; and
storing, by the computing device, configuration information for the virtual application in the database such that the mobile device can selectively download at least two different subsets of the at least three mobile device applications, wherein each of the two different subsets provides different functionality for the virtual application.

2. The method of claim 1 wherein the at least three mobile device applications are configured such that a mobile device can download the at least three mobile device applications so that the virtual application includes full functionality.

3. The method of claim 1 further comprising:
receiving a request from a requesting mobile device for a subset of the at least three mobile device applications; and
transmitting the subset of the at least three mobile device applications to the requesting mobile device.

4. The method of claim 1 further comprising:
receiving a software update for an outdated mobile device application from the at least three mobile device applications;
storing the software update in the database;
identifying a mobile device that downloaded a subset from the at least two different subsets that included the outdated mobile device application; and
transmitting the software update to the identified mobile device.

5. The method of claim 4 wherein transmitting comprises:
transmitting a notification to the identified mobile device, informing the identified mobile device that the software update is available;
receiving a confirmation from the identified mobile device to download the software update to the identified mobile device.

6. The method of claim 1 further comprising receiving a new mobile device application for inclusion into the at least three mobile device applications, wherein the new mobile device application:
comprises an interface defining how the new mobile device application interacts with at least one of the three mobile device applications; and
provides at least one of a new set of services and a new set of features for the virtual application, wherein the virtual application is defined by the at least three mobile device applications, the new mobile device application, and their associated interfaces.

7. The method of claim 6 further comprising:
receiving new configuration information indicative of a new subset of mobile device applications including the new mobile device application and one or more mobile device applications from the at least three mobile device applications; and
storing the new configuration information in the database such that a mobile device can download the new subset of mobile device applications defined by the new subset of mobile device applications.

8. The method of claim 1 wherein one of the at least two different subsets is configured so that when the mobile device executes the virtual application, the virtual application creates a graphical user interface on the mobile device that comprises at least two display areas, each of the at least two display areas displaying data associated with the mobile device application associated with the subset.

9. An application server for providing a virtual mobile device application to a mobile device, the application server comprising:
one or more interfaces configured to provide communication with a mobile device via a communication network;
a database; and
a processor, in communication with the one or more interfaces and the database, and configured to run a module stored in memory that is configured to cause the processor to:
store at least three mobile device applications for a mobile device in the database, wherein:
each of the at least three mobile device applications comprises an interface defining how each mobile device application interacts with the remaining of the at least three mobile device applications;
each of the at least three mobile device applications provides at least one of a set of services and a set of features for a virtual application, wherein the virtual application is defined by the at least three mobile device applications and their associated interfaces; and
store configuration information for the virtual application in the database such that the mobile device can selectively download at least two different subsets of the at least three mobile device applications, wherein each of the at least two different subsets provides different functionality for the virtual application.

10. The application server of claim 9, wherein the module stored in memory is further configured to cause the processor to:
receive, from an interface of the one or more interfaces, a request from a requesting mobile device for a subset of the at least three mobile device applications; and
transmit, using the interface, the subset of the at least three mobile device applications to the requesting mobile device.

11. The application server of claim 9 wherein the module stored in memory is further configured to cause the processor to:
receive, from an interface of the one or more interfaces, a software update for an outdated mobile device application from the at least three mobile device applications;
store the software update in the database;
identify a mobile device that downloaded a subset from the at least two different subsets that included the outdated mobile device application; and
transmit, using the interface, the software update to the identified mobile device.

12. The application server of claim 9 wherein the module stored in memory is further configured to cause the processor to receive, from an interface of the one or more interfaces, a new mobile device application for inclusion into the at least three mobile device applications, wherein the new mobile device application:
comprises an interface defining how the new mobile device application interacts with at least one of the three mobile device applications; and
provides at least one of a new set of services and a new set of features for the virtual application, wherein the virtual application is defined by the at least three mobile device applications, the new mobile device application, and their associated interfaces.

13. A non-transitory computer readable medium having executable instructions operable to cause an apparatus to:
store at least three mobile device applications for a mobile device in a database, wherein:
each of the at least three mobile device applications comprises an interface defining how each mobile device application interacts with the remaining of the at least three mobile device applications; and
each of the at least three mobile device applications provides at least one of a set of services and a set of features for a virtual application, wherein the virtual application is defined by the at least three mobile device applications and their associated interfaces; and
store configuration information for the virtual application in the database such that the mobile device can selectively download at least two different subsets of the at least three mobile device applications, wherein each of the at least two different subsets provides different functionality for the virtual application.

14. The computer readable medium of claim 13 wherein the at least three mobile device applications are configured such that a mobile device can download the at least three mobile device applications so that the virtual application includes full functionality.

15. The computer readable medium of claim 13 wherein the executable instructions are further operable to cause an apparatus to:
receive a request from a requesting mobile device for a subset of the at least three mobile device applications; and
transmit the subset of the at least three mobile device applications to the requesting mobile device.

16. The computer readable medium of claim 13 wherein the executable instructions are further operable to cause an apparatus to:
receive a software update for an outdated mobile device application from the at least three mobile device applications;
store the software update in the database;
identify a mobile device that downloaded a subset from the at least two different subsets that included the outdated mobile device application; and
transmit the software update to the identified mobile device.

17. The computer readable medium of claim 16 wherein transmitting the software update comprises:
transmitting a notification to the identified mobile device, informing the identified mobile device that the software update is available;
receiving a confirmation from the identified mobile device to download the software update to the identified mobile device.

18. The computer readable medium of claim 13 wherein the executable instructions are further operable to cause an apparatus to receive a new mobile device application for inclusion into the at least three mobile device applications, wherein the new mobile device application:
comprises an interface defining how the new mobile device application interacts with at least one of the three mobile device applications; and
provides at least one of a new set of services and a new set of features for the virtual application, wherein the virtual application is defined by the at least three mobile device applications, the new mobile device application, and their associated interfaces.

19. The computer readable medium of claim 18 wherein the executable instructions are further operable to cause an apparatus to:
receive new configuration information indicative of a new subset of mobile device applications including the new mobile device application and one or more mobile device applications from the at least three mobile device applications; and
store the new configuration information in the database such that a mobile device can download the new subset of mobile device applications defined by the new subset of mobile device applications.

20. The computer readable medium of claim 13 wherein one of the at least two
different subsets is configured so that when the mobile device executes the virtual application, the virtual application creates a graphical user interface on the mobile device that comprises at least two display areas, each of the at least two display areas displaying
data associated with the mobile device application associated with the subset.
